(19) United States
(12) Patent Application Publication
(10) Pub. No.: US 2024/0365226 A1
(43) Pub. Date: Oct. 31, 2024

(54) ESTIMATING THE CHARACTERISTIC PARAMETERS OF A RECEPTION QUALITY IN A LOCATION OF A CELLULAR RADIOCOMMUNICATION NETWORK FROM AN APPROXIMATION OF CORRELATION COEFFICIENTS

(71) Applicant: Orange, Issy-les-Moulineaux (FR)

(72) Inventors: Imed HADJ KACEM, CHATILLON CEDEX (FR); Sana BEN JEMAA, CHATILLON CEDEX (FR)

(21) Appl. No.: 18/648,101

(22) Filed: Apr. 26, 2024

(30) Foreign Application Priority Data
Apr. 28, 2023 (FR) 2304341

(51) Int. Cl. H04W 48/20; H04B 17/309; H04B 17/318; H04W 16/18; H04W 24/02

(52) U.S. Cl. CPC H04W 48/20; H04B 17/328; H04B 17/346; H04W 16/18; H04W 24/02

(57) ABSTRACT

A method for estimating the characteristic parameters of a reception quality in a location of a cellular radiocommunication network. This method includes: selecting from a set of cells of the network, at least two cells offering the highest mean reception powers of a useful signal at the location; determining, on the logarithmic scale, at least two signal to interference plus noise ratios at the location for the received useful signal coming from each of the at least two cells selected; determining a correlation coefficient between the at least two signal to interference plus noise ratios determined on the logarithmic scale, determining a maximum between the at least two signal to interference plus noise ratios determined on the logarithmic scale; estimating the characteristic parameters of a reception quality at the location from the maximum and from the correlation coefficient.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application claims foreign priority to French Application No. 2304341, entitled “ESTIMATING THE CHARACTERISTIC PARAMETERS OF A RECEPTION QUALITY IN A LOCATION OF A CELLULAR RADIOCOMMUNICATION NETWORK FROM AN APPROXIMATION OF CORRELATION COEFFICIENTS” and filed Apr. 28, 2023, the content of which is incorporated by reference in its entirety.

### BACKGROUND

### Technical Field

The field of the development is that of cellular radiocommunications, for example in cellular communication networks of the 3G, 4G, 5G type or above. More precisely, the development relates to estimating the characteristic parameters of a reception quality of a useful signal, at all points of such networks, for the purposes for example of planning or of optimizing the resources of the network, or also of monitoring its performance.

### Prior Art

Cellular radiocommunication networks are conventionally structured in neighboring cells, each of which is equipped with one or more base stations each embedding a plurality of transmitting antennas. The cells form a tiling of a geographical area, and one objective of the operator of the radiocommunication network is to ensure a radio coverage, for its users, over the entire geographical area considered, i.e. to ensure access to the services that it proposes at any point of this geographical area, by avoiding as far as possible the occurrence of dead spots.

In a radio environment of the type 3G (also called Universal Mobile Telecommunications System (UMTS)), 4G (also called Long Term Evolution (LTE)) and 5G (or fifth-generation radio communications network), the transmitting antennas of neighboring cells transmit useful signals in the same frequency band. At a given moment, each user terminal is attached to one of the cells of the network, that is commonly called a serving cell, and from which it receives the useful signal that it needs.

However, in addition to the useful signal sent by its serving cell, a user terminal also receives interfering signals coming from other cells in the coverage area in which it is located. The capacity of the user terminal to correctly decode the signal that is intended for it depends on the reception power of the useful signal and of the interferences, and more particularly on the ratio of these two quantities. The “SINR” (Signal to Interference plus Noise Ratio) metrics is the ratio of the power of the useful signal divided by the sum of the powers of the interfering signals and of the thermal noise, received at the receiver of the user terminal. If the user terminal is able to correctly decode the useful signal that is intended for it for a given service, then this service is accessible with a sufficient quality at the place of the terminal.

Therefore, the coverage area for this service can be defined as all the places, within the cell, where the received SINR is greater than a given threshold. The operator dimensions and configures its network according to its objectives including the coverage, for example 99% of the territory must be covered for the voice service, 95% for the video service, etc. As the coverage cannot be measured in any place of the network, accurate estimation of the SINR and of its characteristic parameters is decisive for ensuring the coverage objectives of the operator.

However, the signal transmitted by a base station and received by a user terminal is subject to variations related to the nature of the radio environment. Indeed, the reception powers at the two user terminals located at the same distance from the base station are different due to the fact that the obstacles existing on the routes between each user terminal and the base station are different (reflection phenomena on the significant obstacles, such as buildings in urban environments or forests in rural environments for example). In this case, reference is made to the random shadowing phenomenon that adds a fading term in the expression of the power of the radio signal received by the user terminal.

As indicated above, in a cellular radiocommunication network, a user terminal is typically attached to the cell offering it the highest reception power, that is commonly called its serving cell. In order to estimate the coverage offered in each location of the radiocommunication network, first of all it is therefore necessary to determine which is the serving cell in this location, then the interfering cells, and subsequently to estimate the associated SINR. Nevertheless, in the absence of measurements and due to the random variation of the powers of the signals received at a given location (shadowing phenomenon), the identity of the serving cell is not always deterministically known, and it may vary statistically, especially at the edge of the cells.

However, for the purposes of simplification, previously published works on this subject are based on the hypothesis that in a given location of the network, the serving cell is “frozen”, and corresponds for example to the cell from which the useful signal is received having the highest mean reception power for the user terminal.

Thus, in the article “SINR and rate distributions for downlink cellular networks”, IEEE Transactions on Wireless Communications, vol. 19, no. 7, pp. 4604-4616, 2020, published by the inventors of the present patent application, the authors propose to evaluate the service quality perceived by a user terminal from the statistical distribution of the SINR, which is approximated in the form of a normal random variable in the logarithmic domain, of which the mean and the variance can be calculated. These works are based on the simple hypothesis that in a given location of the network, a user terminal receives a useful signal from a frozen serving cell k, and M interfering signals coming from M neighboring cells. The SINR in this location is then defined as the ratio of the power of the useful signal received from this serving cell k to the sum of the power of the thermal noise and of the power of the interfering signals received from the M neighboring cells.

In the article, “Downlink average rate and SINR distribution in cellular networks,” IEEE Transactions on Communications, vol. 64, no. 2, pp. 847-862, February 2016,X. Yan et al. are more particularly interested in cellular networks based on an Orthogonal Frequency Division Multiple Access (OFDMA) technique, and propose another approach for the statistical modeling of the SINR. Their works are also based on the simplifying hypothesis that in a given location (r, θ) of the network, a user terminal receives a useful signal from a base station BS₀ of a frozen serving cell, and L interfering signals coming from base stations BSᵢ of i interfering neighboring cells.

In each of these two publications, the characteristic parameters proposed for estimating the distribution of the SINR are only valid if the serving cell of a user terminal remains effectively unchanged. Yet, in an actual environment, in which the random shadowing phenomenon is added to the mean power of the signal received by a user terminal, often a plurality of nearby cells statistically exchange the role of serving cells, in a given location of the network.

Thus, the approximation on which these two articles of the prior art are based is satisfactory when the deviation between the mean power of the signal received from a first cell having the highest value and the mean power of the signal received from a second cell having the second highest value is fairly important, typically for user terminals close to the center of the cell. However, it reaches its validity limits for user terminals at the edge of the cells. Yet, it should be noted that the area at the edge of the cells is the area where it is important, for the operator of the network, to know precisely the SINR in order to guarantee the coverage.

Therefore, there is a need for a technique for estimating the characteristic parameters of a reception quality in a location of a cellular radiocommunication network that improves these works of the prior art. In particular, there is a need for such a technique that improves the estimation of the quality of signals received at any point of a cellular radiocommunication network, and particularly, but not exclusively, in the locations at the edge of the cells.

There is also a need for such a technique that makes it possible to improve the estimation of characteristics of the SINR, for the purposes particularly of planning, of optimizing radio coverage or also of monitoring the performance of a cellular radiocommunication network.

### SUMMARY

The development meets this need by proposing a method for estimating the characteristic parameters of a reception quality in a location of a cellular radiocommunication network. This method comprises:
selecting from a set of cells of the network, at least two cells offering the highest mean reception powers of a useful signal at the location;
determining, on the logarithmic scale, at least two signal to interference plus noise ratios at the location for the received useful signal coming from each of said at least two cells selected;
determining a correlation coefficient between said at least two signal to interference plus noise ratios determined on the logarithmic scale,
determining a maximum between said at least two signal to interference plus noise ratios determined on the logarithmic scale;
estimating the characteristic parameters of a reception quality at said location from said maximum and from said correlation coefficient.

Thus, the development is based on a completely novel and inventive approach for estimating the reception quality at any point of a network, for the purposes for example of planning the network, of optimizing an existing cellular radiocommunication network, or also of monitoring the performance of a network. Indeed, the techniques of the prior art in terms of estimating the reception quality are all based on the hypothesis that in a given location of the network, there is a single serving cell, frozen over time, to which a user terminal is attached. This is the hypothesis on which are based the proposals of the aforementioned articles “SINR and rate distributions for downlink cellular networks”, IEEE Transactions on Wireless Communications, vol. 19, no. 7, pp. 4604-4616, 2020, published by the inventors of the present patent application and “Downlink average rate and SINR distribution in cellular networks,” IEEE Transactions on Communications, vol. 64, no. 2, pp. 847-862, February 2016, by X. Yan et al.

As opposed to these prior works, the estimation technique according to one embodiment of the development considers the realistic case where the serving role may statistically be played by a plurality of neighboring cells, which is particularly frequent in the case where the user terminal is located at the edge of the cells, due to the random nature of the shadowing phenomenon. Thus, the present solution endeavors to identify two or more cells that may potentially act as serving cells in a given location, it being understood that at a given moment, a user terminal is only attached to a single serving cell, from which it receives the useful signal. It further proposes a method for calculating the characteristic parameters of the signal to interference plus noise ratio measured for the user terminal in this realistic case, from signal to interference plus noise ratios measured for the user terminal for each of the radio signals transmitted by the plurality of cells likely to act as serving cells, namely those of which the reception power of the useful signal in this location is the highest.

This signal to interference plus noise ratio, that can be qualified as realistic in view of the work hypothesis formulated, is calculated in the form of a maximum, on the logarithmic scale, of the signal to interference plus noise ratios of the various potential serving cells.

Advantageously, in order to be able to estimate the characteristic parameters of the reception quality in a given location, the method is based on determining a correlation coefficient between the signal to interference plus noise ratios previously determined.

Knowledge of the maximum of the signal to interference plus noise ratios and of a correlation coefficient between these signal to interference plus noise ratios makes it possible to estimate a certain number of characteristic parameters of the reception quality in a given location, and particularly the probability, over a geographical area, of having a signal to interference plus noise ratio greater than a given threshold, in order to estimate for example the quality of the coverage of the cellular radiocommunication network.

According to a particular embodiment, the correlation coefficient is determined from an approximation of a mean of a product of said at least two signal to interference plus noise ratios.

According to the works of S C. E. Clark, “The greatest of a finite set of random variables,” in Operations Research, Vol. 9, No. 2, 145-162, 1961, the mean and the variance can be calculated for the maximum of two correlated normal random variables, assuming known the correlation coefficient between these two variables. In the case of the planning and of the optimization of a cellular network, the correlation coefficient between the SINRs of two potentially serving cells on the logarithmic scale is not a known quantity. Thus, according to one embodiment of the development, the mean of the product of the SINRs is approximated on the logarithmic scale and subsequently the correlation coefficient is determined. In other terms, according to this embodiment, the correlation coefficient is approximated based on a mathematical calculation of bounds. Therefore, the implementation of the method is easy to put in place and requires a lower computing power for the tools for planning and optimizing the network.

Thus, it is possible to determine the correlation coefficient between the SINRs at each point of the radiocommunication network where it is desired to optimize the latter.

According to another particular embodiment, said correlation coefficient is determined from:
a calculation of at least two signal to interference plus noise ratios only taking into account a single cell generating interferences offering the highest mean reception power of a useful signal at said location; and
at least two variances representative of an impact on the mean reception powers of said useful signal, of obstacles that said useful signal encounters during its propagation.

Advantageously, the determination of the correlation coefficient is particularly easy to implement using the tools for planning and optimizing the network. Indeed, the expression of the correlation coefficients corresponds to a simple mathematical expression. Therefore, there is no need to produce Monte Carlo type embodiments to generate the correlation coefficients.

According to one embodiment, the method according to the development further comprises calculating a mean and a variance of said at least two signal to interference plus noise ratios determined on the logarithmic scale. The correlation coefficient is then determined according to the formula:

$${τ}_{ij} = \frac{E [ {SINR}_{i}^{d B} {SINR}_{j}^{d B} ] - {q}_{i} {q}_{j}}{{s}_{i} {s}_{j}}$$

where:

SINRᵢ and SINRⱼ respectively designate said at least two signal to interference plus noise ratios determined on the logarithmic scale of at least two cells,

qᵢ and qⱼ respectively designate said means of said at least two signal to interference plus noise ratios determined on the logarithmic scale,
sᵢ and sⱼ respectively designate said variances of said at least two signal to interference plus noise ratios determined on the logarithmic scale.

As will be seen in detail in the remainder of this document, the characteristic parameters of the distributions (mean and variance) of signal to interference plus noise ratios for cells are calculated, for example according to the Schwartz-Yeh technique described in the article by C.-L. Ho, “Calculating the mean and variance of power sums with two log-normal components,” IEEE Trans. Veh. Technol., vol. 44, no. 4, pp. 756-762, 1995.

Thus, it is possible to apply the C. E. Clark study, “The greatest of a finite set of random variables,” in Operations Research, Vol. 9, No. 2, 145-162, 1961, in order to calculate the mean and variance characteristic parameters of the maximum SINR (SINRdB).

According to a particular aspect, estimating the characteristic parameters comprises calculating at least some of the elements belonging to the group comprising:
a mean of said calculated maximum;
a variance of said calculated maximum;
from the determined correlation coefficient and from the means and variances of said at least two signal to interference plus noise ratios determined on the logarithmic scale.

Thus, the technique of the development makes it possible to calculate the expressions of the mean and of the variance on the logarithmic scale of the maximum of the SINRs. Knowing the mean and the variance makes it possible to optimize the most accurate network coverage of the operator.

According to another particular aspect, the mean of the calculated maximum is calculated according to the formula:

$${q}_{z} = {q}_{i} Φ ( \frac{{q}_{i} - {q}_{j}}{θ} ) + {q}_{j} Φ ( \frac{{q}_{j} - {q}_{i}}{θ} ) + θ ϕ ( \frac{{q}_{i} - {q}_{j}}{θ} )$$

where:

$$θ = \sqrt{{s}_{i}^{2} + {s}_{j}^{2} - 2 {τ}_{i j} {s}_{i} {s}_{j}} ,$$

ϕ(.) is the probability density function of the standard centered normal law,
Φ(.) is the distribution function of the standard normal law,
qᵢ and qⱼ respectively designate said means of said at least two signal to interference plus noise ratios determined on the logarithmic scale,
sᵢ² and sⱼ² respectively designate said variances of said two signal to interference plus noise ratios determined on the logarithmic scale, and

τᵢⱼ is said correlation coefficient between said two signal to interference plus noise ratios determined on the logarithmic scale.

According to another particular aspect, said variance of said calculated maximum is calculated according to the formula:

$${s}_{z}^{2} = ( {s}_{i}^{2} + {q}_{i}^{2} ) Φ ( \frac{{q}_{i} - {q}_{j}}{θ} ) + ( {s}_{j}^{2} + {q}_{j}^{2} ) Φ ( \frac{{q}_{j} - {q}_{i}}{θ} ) + ( {q}_{i} + {q}_{j} ) θ ϕ ( \frac{{q}_{i} - {q}_{j}}{θ} ) - {( {q}_{z} )}^{2}$$

where:

$$θ = \sqrt{{s}_{i}^{2} + {s}_{j}^{2} - 2 {τ}_{i j} {s}_{i} {s}_{j}} ,$$

ϕ(.) is the probability density function of the standard centered normal law,
Φ(.) is the distribution function of the standard normal law,
qᵢ and qⱼ respectively designate said means of said two signal to interference plus noise ratios determined on the logarithmic scale,
sᵢ² and sⱼ² respectively designate said variances of said two signal to interference plus noise ratios determined on the logarithmic scale,
τᵢⱼ is said correlation coefficient between said two signal to interference plus noise ratios determined on the logarithmic scale, and
q_{z} is said mean of said calculated maximum.

According to a particular embodiment, determining the maximum between said at least two signal to interference plus noise ratios determined on the logarithmic scale, comprises, where applicable, determining, from said at least two cells selected, at least two cells mutually having an mean power difference greater than or equal to a predetermined threshold (λ).

Advantageously, from the cells selected that may potentially be serving cells, it is possible to not take into account cells offering a very low mean reception power relative to the cells offering high mean reception powers. Indeed, when the mean reception power for a signal transmitted by a cell k is much lower than the mean power offered by a cell i offering the highest mean reception power from the potentially serving cells selected, the probability for the SINR of the cell k to be the maximum is negligible. Thus, in order to simplify the calculation of the maximum of the SINRs, it is judicious not to take this cell k into account. For this purpose, a threshold λ (greater than 0; in dB) is set for which if a cell offers an mean reception power deviating by more than λ from the highest mean reception power, then its SINR is not taken into consideration for calculating the maximum of the SINRs.

The development also relates to a computer program product comprising program code instructions for the implementation of a method for estimating the characteristic parameters of a reception quality in a location of a cellular radiocommunication network as described above, when it is executed by a processor.

Another aim of the development is a computer-readable storage medium on which a computer program is stored comprising program code instructions for the execution of the steps of the method for estimating the characteristic parameters of a reception quality in a location of a cellular radiocommunication network according to the development as described above.

Such a recording medium may consist of any entity or device capable of storing the program. For example, the medium can include a storage means, such as a ROM, for example a CD-ROM or a ROM of a microelectronics circuit, or also a magnetic storage means, for example a flash drive or a hard drive.

Besides, such a storage medium may be a transmissible medium such as an electrical or optical signal, which could be conveyed via an electrical or optical cable, by radio waves or by other means, so that the computer program contained therein is remotely executable. In particular, the program according to the development may be downloaded on a network, for example the Internet network.

Alternatively, the recording medium may be an integrated circuit in which the program is incorporated, the circuit being adapted to execute or to be used in the execution of the aforementioned method for estimating the characteristic parameters of a reception quality in a location of a cellular radiocommunication network.

The development also relates to a method for planning the deployment of a cellular radiocommunication network, which implements estimating characteristic parameters of a reception quality in a location of said network according to the method described above, and a determination of parameters for planning the network depending on the estimated characteristic parameters.

Such a method may for example be implemented in planning tools of the Merit/Acp® or Atoll® type for example.

It also relates to a method for optimizing the operating parameters of a cellular radiocommunication network, which implements estimating characteristic parameters of a reception quality in a location of said network, according to the method described above, and a determination of optimized operating parameters of the network depending on the estimated characteristic parameters.

Such a method can be integrated into optimization tools of the CSON® type.

The development also relates to a method for monitoring the performance of a cellular radiocommunication network, which implements estimating characteristic parameters of a reception quality in a location of said network, according to the method described above, and an estimation of at least one performance criterion of the network depending on the estimated characteristic parameters.

The development also relates to a method for planning the deployment of a cellular radiocommunication network, which comprises a processor configured to execute the steps of the method for estimating the characteristic parameters of a reception quality in a location of said network, as described above, and for determining the parameters for planning the network depending on the estimated characteristic parameters.

The development also relates to a system for optimizing the operating parameters of a cellular radiocommunication network, which comprises a processor configured to execute the steps of the method for estimating the characteristic parameters of a reception quality in a location of said network, as described above, and for determining the optimized operating parameters of the network depending on the estimated characteristic parameters.

Finally, the development relates to a system for monitoring the performance of a cellular radiocommunication network, which comprises a processor configured to execute the steps of the method for estimating the characteristic parameters of a reception quality in a location of said cellular radiocommunication network as described above and for analyzing a performance of said network depending on the estimated characteristic parameters.

### BRIEF DESCRIPTION OF THE DRAWINGS

Other aims, features and advantages of the development will become apparent upon reading the following description, given simply by way of illustrative and non-limiting example, with reference to the figures, in which:

FIG. 1 schematically shows a cellular radiocommunication network to which the estimation method may be applied according to various embodiments of the development;

FIG. 2 schematically illustrates the existence of a common propagation area for the correlated cells of the network of FIG. 1;

FIG. 3 describes in the form of a flow chart the main steps of the estimation method according to a first embodiment of the development;

FIG. 4 describes in the form of a flow chart the main steps of the estimation method according to a second embodiment of the development;

FIG. 5 shows in the form of a bar chart the absolute value of the error on the calculation of the mean of the SINR perceived by the user at the location of interest, on the logarithmic scale, according to the embodiment of the development in connection with FIG. 3;

FIG. 6 shows in the form of a bar chart the absolute value of the error on the calculation of the mean of the SINR perceived by the user at the location of interest, on the logarithmic scale, according to the embodiment of the development in connection with FIG. 4;

FIG. 7 schematically shows the hardware structure of a system for monitoring the performance of a cellular radiocommunication network of FIG. 1 in one embodiment of the development.

### DETAILED DESCRIPTION OF CERTAIN ILLUSTRATIVE EMBODIMENTS

The general principle of the development is based on estimating the characteristic parameters of the reception quality of a useful signal at any point of a cellular radiocommunication network, based on a realistic hypothesis consisting in considering that a plurality of cells are likely to act as serving cells, in a given location, due to the random shadowing phenomenon.

The proposed solution makes it possible to calculate the expressions of the mean and of the variance on the logarithmic scale of the “actual” SINR, that is to say measured for a user terminal, at any point of a cellular radiocommunication network. Knowing the mean and the variance of the SINR makes it possible to more accurately optimize the coverage of the network of an operator.

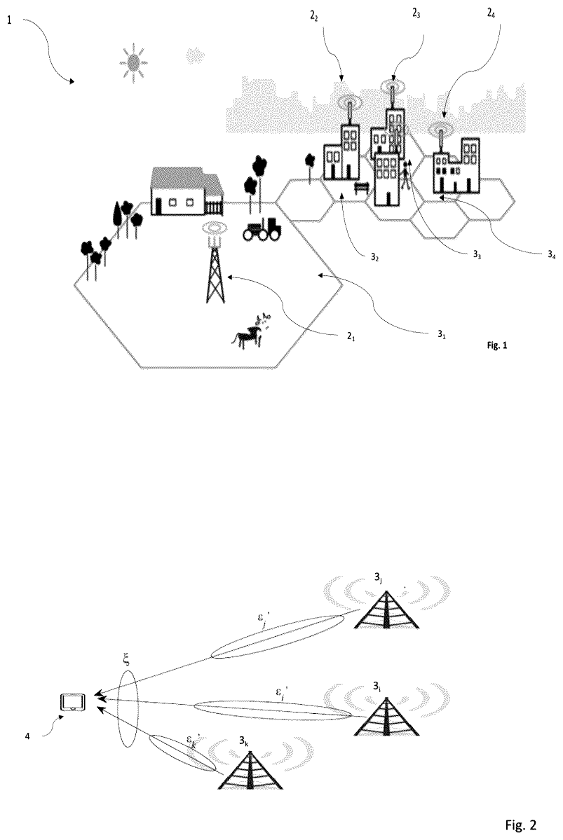

As a reminder, and as illustrated in FIG. 1, a cellular radiocommunication network 1, or mobile network, is made up of a network of relay antennas (or base stations) 2ₗto 2_{N} (N=4 in the example shown), each covering a delimited portion of territory 3ₗ to 3_{P} (P=4 in the example shown), commonly called a cell (schematically shown in hexagonal form in FIG. 1), and routing the communications in the form of radio waves to and from user terminals located in the corresponding cell.

In order to access the services proposed by the operator of the network (voice or data), a user terminal must therefore be located in the coverage area of a relay antenna 2ᵢ. This has a limited range, and only covers a restricted territory around it, called a cell. In order to cover a maximum of territory and make sure that the user terminals always have access to the proposed services, the operators deploy thousands of cells 3ᵢ, each of them being equipped with antennas 2ᵢ making sure that their coverage areas overlap, so as to offer a meshing of the territory that is as comprehensive as possible.

Indeed, if a user terminal is able to correctly decode the signal that is intended for it for a given service, then this service is accessible with a sufficient quality at the place of the user terminal. The coverage area for this service is all the places where the SINR determined for the user terminal is greater than a given threshold. The operator dimensions and configures its network according to its objectives including the coverage, for example 99% of the territory must be covered for the voice service, 95% for the video service, etc. As the coverage cannot be measured at any place of the network, the accurate estimation of the SINR and of its characteristic parameters is decisive for ensuring the coverage objectives of the operator.

It will be noted that the size of the cells depends on multiple criteria such as the type of relay antennas used, the relief (plain, mountain, valley, etc.), the installation site (rural area, urban area, etc.), the population density, etc. The size of the cell 3; is also limited by the range of the user terminals, which must be able to establish an uplink with the relay antenna.

Moreover, a relay antenna 2ᵢ has a limited transmission capacity, and can only process a certain number of simultaneous requests to access the service. This is why, in cities, where the population density is high and the number of communications is significant, the cells tend to be high in number and small in dimension—spaced a few hundreds or even only a few tens of meters apart. In the countryside, where the population density is much lower, the size of the cells is much larger, sometimes reaching up to several kilometers but only very rarely exceeding more than ten kilometers.

The planning and the optimization of the operation of a cellular radiocommunication network 1 are therefore complex and delicate issues for the operator of the network. They require having reliable and accurate information relating to the reception quality that a given configuration of relay antennas and cells may offer at any point of the network. This information can be obtained by knowing the signal to interference plus noise ratio, or SINR, at any point of the network. However, as the latter cannot be measured effectively at any point of the network, it is important for the operator to be able to have a statistical estimation of this parameter and of its variance and mean characteristics. The estimation of the characteristics of the SINR is then used by the operator in planning tools in order to optimize the radio coverage.

The aim of the technique of the development is to propose a method for estimating the SINR at any location of the network, starting from the hypothesis that a plurality of cells may potentially act as serving cells in any given point, due to the random shadowing phenomenon.

More particularly hereinafter, with reference to FIGS. 2 to 4, it is endeavored to describe the estimation of the SINR actually measured for a user terminal 4 at a location of interest, in the case where it is considered that a plurality of cells of the network may act as serving cells in this location of interest.

According to a conventional approach in the context of simulating the radio coverage of a network, here it is assumed that the values of the loads (p) of the cells are equal. As a reminder, the load (ρ) of a cell corresponds to the fraction of resources granted by it to user terminals located in its coverage area.

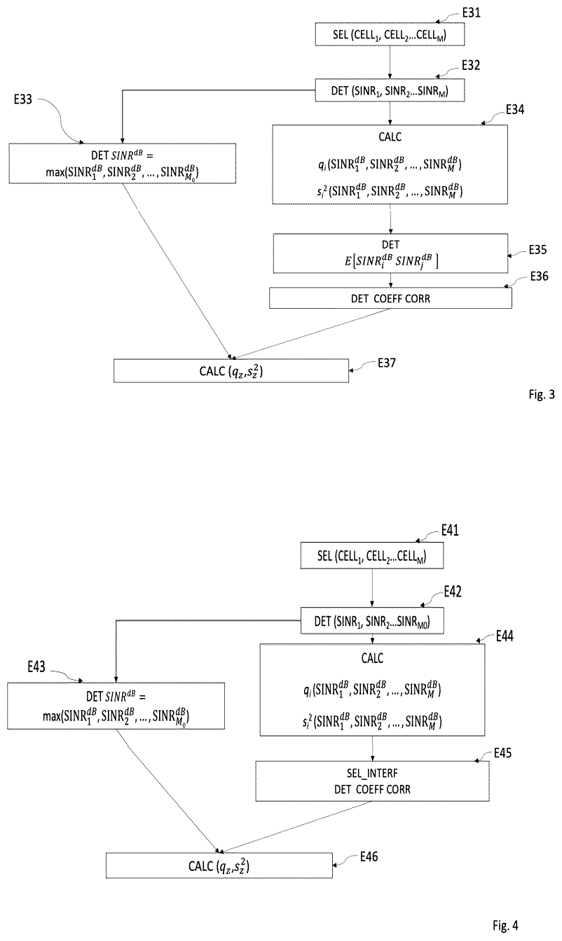

First of all, in connection with FIG. 3, a first embodiment according to the development is described. During a step E31, a set is selected comprising at least two cells that can potentially act as serving cells for a user terminal in a given location. In particular, it is sought to select the cells of the communication network that offer the highest mean reception power of a useful signal at the location of the user terminal 4. In other terms, the cells for which the user terminal 4 captures a useful signal are selected. In one example in connection with FIG. 2, the following three cells are selected from the cells of the communication network: 3ᵢ, 3ⱼ, 3ₖ.

In another example in connection with FIG. 3, or FIG. 4, a number M of cells (M being an integer greater than or equal to 1) is considered: cell 1, cell 2 . . . up to the cell M (respectively denoted: CELL₁, CELL₂ . . . CELL_{M}).

As a reminder, the expression of the SINR/measured for a user terminal at a location of interest in the case where its serving cell is the cell i is:

$${SINR}_{i} = \frac{{10}^{\frac{{μ}_{i} + {ε}_{i}}{10}}}{N + {\sum }_{j = 1 , j \neq i}^{M} {ρ}_{j} {10}^{\frac{{μ}_{j} + {ε}_{j}}{10}}} \qquad ( EQ1 )$$

where

Mis the number of cells from which the user terminal located in the location of interest captures a useful signal,

N is the power of the thermal noise,

for 1≤i≤M, μᵢ is the mean power of the signal received from the cell i. Without loss of generality, it is assumed that, μ1≥μ2≥ . . . ≥μ_{M}. In other words, it is subsequently considered that the cell 1 (CELL₁) offers an mean reception power greater than the cell 2 (CELL₂) that has an mean reception power greater than the cell 3 (CELL₃) etc. . . . the cell M (CELL_{M}) therefore offering the lowest mean reception power from the set of cells selected in step E31,
εᵢ is a centered normal random variable of variance σᵢ² that designates the shadowing and
ρⱼ designates the load of the cell j. As described above, here it is assumed that the values of the loads of the cells are equal, that is to say: ρ₁= . . . =ρ_{M}=ρ.

Due to the shadowing phenomenon, the serving cell is not “frozen” and a plurality of cells may statistically act as serving cells. The serving cell of the user terminal at the location of interest is therefore that which offers the highest received power, and not necessarily that which offers the highest mean reception power. In other words, if the cell i is the serving cell, then: μᵢ+εᵢ>μⱼ+εⱼ(for any j≠i).

The random shadowing variables of the various cells considered are correlated since they correspond to the impact on the power received by the user terminal, obstacles that the signal overcomes during its propagation from a relay antenna to the user terminal. These obstacles present in the immediate environment of the user terminal are consequently the same for the various cells considered. The shadowing impacting the path i, j, k (coming from the cell 3ᵢ, 3ⱼ, 3ₖ and going to the user terminal 4) is therefore the sum of two random Gaussian variables independent of one another of which one ξ is common to all the paths i, j, k going to the user terminal 4 as shown in FIG. 2. In this respect, reference can be made to the works of S. S. Szyszkowicz, H. Yanikomeroglu, and J. S. Thompson, “On the feasibility of wireless shadowing correlation models,” IEEE Trans. Veh. Technol., vol. 59, no. 9, pp. 4222.

Thus, it can be written that

$${ε}_{i} = {ε}_{i}^{′} + ξ ,$$

$${ε}_{j} = {ε}_{j}^{′} + ξ$$

$${ε}_{k} = {ε}_{k}^{′} + ξ$$

Where ε′ᵢ, ε′ⱼ, ε′ₖ and ξ (1≤i≠j≠k≤M) are independent normal random variables of zero means and of variances σᵢ′²=σᵢ²−β², σⱼ′²=σⱼ²−β, σₖ′²σₖ²−β² and β², respectively, where β² is the variance of ξ.

During a step E32, for calculating the characteristic parameters of the so-called “actual” SINR, that is to say measured for the user terminal, in the realistic case where this shadowing phenomenon is taken into account, using the preceding equation EQ1 the expressions of the SINRs (SINR₁, SINR₂ . . . SINR_{M}) measured for each cell of the set of cells (CELL₁, CELL₂ . . . CELL_{M}) selected during the step E31 are determined. In this case, it is considered that each cell may potentially act as serving cells.

Consequently, if it is considered that the cells (CELL₁, CELL₂ . . . CELL_{M}) selected may statistically act as serving cells, the SINR measured for the user terminal at the location of interest therefore amounts to determining a maximum between all the SINRs (SINR₁, SINR₂ . . . SINR_{M}) measured, that is to say:

$${SINR}^{d B} = max ( {SINR}_{1}^{d B} , {SINR}_{2}^{d B} , … , {SINR}_{M}^{d B} )$$

$$where$$

$${SINR}_{i}^{d B} = 10 {log}_{10} {SINR}_{i} ,$$

$$1 \leq i \leq M ;$$

$$and$$

$${SINR}^{d B} = 10 {log}_{10} SINR .$$

It should be noted that if a cell k offers a very low mean reception power (μₖ) relative to that of the first cell (CELL₁) (in the present case, it is assumed that the first cell has the highest mean reception power from the set of cells 1 to M), in other words μₖ<μ₁, then the probability that the SINR (SINRA) measured for the cell k corresponding to the maximum of the SINRs is negligible. Thus, taking the cell k into account adds more complexity than accuracy in the calculation of the maximum of the SINRs.

In order to simplify the calculation of the maximum of the SINRs, it is therefore judicious to not take this cell k into account. Thus, it is considered that if μₖ<μ₁−λ(dB) where λ>0, the cell is not considered as potentially a serving cell. λ is a configurable variable making it possible to place a limit on the number of cells to be taken into consideration for calculating the maximum of the SINRs. For example, if λ=20 dB is set, then all the cells having an mean u deviating by more than 20 dB from the highest mean reception power are not taken into consideration for calculating the maximum SINR (that is to say SINRdB), because the possibility that these cells act as serving cells is negligible.

Therefore, the number of cells to be taken into consideration in the calculation of the maximum SINR can be reduced. Therefore, it is considered that M₀≤M is the number of cells of which the mean powers are greater than or equal to μ₁−λ in dB.

Thus, in a step E33, the maximum of the SINRs is determined as follows:

$${SINR}^{d B} = max ( {SINR}_{1}^{d B} , {SINR}_{2}^{d B} , … , {SINR}_{{M}_{0}}^{d B} ) .$$

Typically, M₀=2, 3 or 4 cells.

However, the set of cells M is always considered in the calculation of the SINRᵢ in the equation EQ1. In other terms, for calculating the SINR₁ to SINR_{M} using the equation EQ1, all the M cells are taken into account.

The C. E. Clark study, “The greatest of a finite set of random variables” in Operations Research, Vol. 9, No. 2, 145-162, 1961, enables us to calculate the mean and variance characteristic parameters for the maximum of two correlated normal random variables. Moreover, it should be noted that the maximum between the two normal variables is approximated by a normal distribution. Thus, for the case of the calculation of the maximum of the SINRs where M₀ cells are potentially serving cells, calculating the maximum of the SINRs on the logarithmic scale amounts to maximizing the quantities SINRᵢ^{dB}two by two, 1≤i≤M₀.

For example, for M₀=4,

$${SINR}^{d B} = max ( max [ max ( {SINR}_{1}^{d B} , {SINR}_{2}^{d B} ) , {SINR}_{3}^{d B} ] , {SINR}_{4}^{d B} )$$

However, in the C. E. Clark study, “The greatest of a finite set of random variables,” in Operations Research, Vol. 9, No. 2, 145-162, 1961, the correlation coefficients between the normal random variables are assumed known. On the contrary, in the case of planning and optimizing the cellular network, the correlation coefficient between the SINRs of two neighboring cells on the logarithmic scale is not a known quantity.

It is reminded that the correlation coefficient between SINRᵢ^{DB} and SINRⱼ^{dB} for 1≤i≠j≤M₀ is:

$${τ}_{i j} = \frac{E [ {SINR}_{i}^{d B} {SINR}_{j}^{d B} ] - {q}_{i} {q}_{j}}{{s}_{i} {s}_{j}} \qquad ( EQ2 )$$

In order to be able to apply the C. E. Clark study, “The greatest of a finite set of random variables,” in Operations Research, Vol. 9, No. 2, 145-162, 1961, in order to calculate the mean and variance characteristic parameters of the maximum SINR (SINR^{dB}), first of all the correlation coefficient is determined for one or more pairs of cells.

For this purpose, during a step E34, the characteristic parameters of distribution, that is to say the mean and the variance, of SINRᵢ^{dB} are determined by the Schwartz-Yeh technique, described in the article by C.-L. Ho, “Calculating the mean and variance of power sums with two log-normal components,” IEEE Trans. Veh. Technol., vol. 44, no. 4, pp. 756-762, 1995. Indeed, as indicated in the article “SINR and rate distributions for downlink cellular networks”, IEEE Transactions on Wireless Communications, vol. 19, no. 7, pp. 4604-4616, 2020, the SINRᵢ, (where 1≤i≤M), are normal random variables in the logarithmic domain, of which the mean and the variance can be calculated. It is then noted by qᵢ, sᵢ², respectively the mean and the variance of SINRᵢ^{dB}.

Subsequently, the mean of the product E[SINRᵢ^{dB} SINRⱼ^{dB}], 1≤i≠j≤M₀ is determined during a step E35. The following is then defined:

$${SINR}_{i} = \frac{10 \frac{{μ}_{i} + {ε}_{i}^{′}}{10}}{ρ10 \frac{{μ}_{j} + {ε}_{j}^{′}}{10} + {Y}_{ij}}$$

$${SINR}_{j} = \frac{10 \frac{{μ}_{j} + {ε}_{j}^{′}}{10}}{ρ10 \frac{{μ}_{i} + {ε}_{i}^{′}}{10} + {Y}_{i j}}$$

$$Where$$

$${Y}_{i j} = N 1 {0}^{\frac{ξ}{10}} + {\sum }_{k = 1}^{M} ρ 10 \frac{{μ}_{k} + {ε}_{k}^{′}}{10} - ρ 10 \frac{{μ}_{i} + {ε}_{i}^{′}}{10} - ρ 10 \frac{{μ}_{j} + {ε}_{j}^{′}}{10} .$$

Yᵢⱼ is the sum of (M-1) log-normal random variables, therefore Yᵢⱼ is also log-normal.

On the logarithmic scale, it is possible to define a variable y=10 log(Yᵢⱼ). y is a normal random variable. Thus, the characteristic parameters of y are calculated based on the Schwartz-Yeh technique, described in the article by C.-L. Ho, “Calculating the mean and variance of power sums with two log-normal components,” IEEE Trans. Veh. Technol., vol. 44, no. 4, pp. 756-762, 1995. μ_{Y} denotes (its mean) and σ_{Y}² (its variance). I.e. xᵢ=μᵢ+εᵢ′ and μⱼ=μⱼ+εⱼ′.

xᵢ, xⱼ and y are independent, then: )

$$E [ {SINR}_{i}^{d B} {SINR}_{j}^{d B} ] = {μ}_{i} {μ}_{j} - E [ {x}_{i} {A}_{i} ] - E [ {x}_{j} {A}_{j} ] + E [ {A}_{i} {A}_{j} ] \qquad ( EQ3 )$$

$$where$$

$${A}_{i} = 10 log ( 10 \frac{{x}_{i} + {ρ}_{d B}}{10} + 1 {0}^{\frac{y}{10}} ) ,$$

$${A}_{j} = 10 log ( 10 \frac{{x}_{j} + {ρ}_{d B}}{10} + 1 {0}^{\frac{y}{10}} )$$

$$and$$

$${ρ}_{d B} = 10 log ( ρ ) .$$

It can then be approximated:

$$\{ \begin{matrix}{A}_{i} ≃ ( {x}_{i} + {ρ}_{d B} ) & if {μ}_{i} + {ρ}_{d B} - {μ}_{Y} \geq d \\ {A}_{i} ≃ y & if {μ}_{Y} - {μ}_{i} - {ρ}_{d B} \geq d \\ {A}_{i} ≃ 0.5 ( {x}_{i} + y ) + c & if \vert {μ}_{i} + {ρ}_{d B} - {μ}_{Y} \vert < d\end{matrix}$$

$$Where$$

$$c = 0.5 {ρ}_{d B} + 10 \frac{ln ( 2 )}{ln ( 10 )}$$

and d>0 is a configurable real number.

If the difference between the mean of xⱼ+ρ_{dB} and that of y is greater than or equal to d, it is estimated that

$$1 {0}^{\frac{{x}_{j} + {ρ}_{d B}}{10}} ≫ {10}^{\frac{y}{10}} .$$

Indeed, when

$$1 {0}^{\frac{{x}_{j} + {ρ}_{d B}}{10}} ≫ {10}^{\frac{y}{10}}$$

(i.e. then μᵢ+ρ_{dB}»μ_{Y}), Aᵢ≅xᵢ+ρ_{dB}. Inversely, if

$$10 \frac{{x}_{j} + {ρ}_{d B}}{10} ≪ {10}^{\frac{y}{10}}$$

$$( i . e . then {μ}_{i} + {ρ}_{d B} ≪ {μ}_{Y} ) ,$$

$${A}_{i} ≃ {x}_{i} .$$

$$Otherwise ,$$

$${A}_{i} = {x}_{i} + {ρ}_{d B} + 10 log ( 1 + 1 {0}^{\frac{y - {x}_{i} - {ρ}_{d B}}{10}} ) .$$

It should be noted that for any x>0, this gives log

$$( 1 + x ) \geq \frac{ln ( 2 )}{ln ( 10 )} + 0.5 log ( x ) .$$

Indeed, if a function F(x)=ln(1+x)−ln(2)−0.5 ln (x) is considered, then the derivative of F is

$${F}^{′} ( x ) = \frac{x - 1}{2 x ( 1 + x )} .$$

Its vanauon table is:

Thus, for any x>0, F(x)≥0. By dividing by ln(10),

$$\frac{F ( x )}{ln ( 10 )} \geq 0 .$$

### Hence,

$$log ( 1 + x ) \geq \frac{ln ( 2 )}{ln ( 10 )} + 0.5 log ( x ) .$$

By applying this result, this gives,

$$log ( 1 + 1 {0}^{\frac{y - {x}_{i} - {ρ}_{dB}}{10}} ) \geq \frac{ln ( 2 )}{ln ( 10 )} + 0.5 \frac{y - {x}_{i} - {ρ}_{dB}}{10} .$$

In the case where the deviation between the quantities μᵢ+ρ_{dB} and μ_{Y} is not very high, it is approximated

$$log ( 1 + 1 {0}^{\frac{y - {x}_{i} - {ρ}_{dB}}{10}} ) ≃ \frac{ln ( 2 )}{ln ( 10 )} + 0.5 \frac{y - {x}_{i} - {ρ}_{dB}}{10} .$$

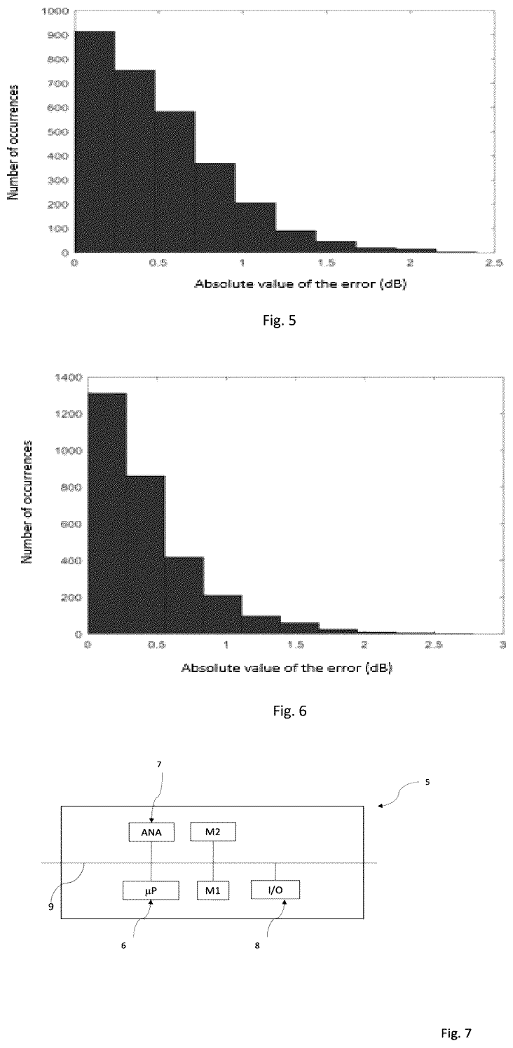

Advantageously, as shown below in connection with FIG. 5, the error on the estimation of the correlation coefficient has little impact on the accuracy for estimating the characteristic parameters of the SINR on the logarithmic scale (mean and variance). In summary:

$$\{ \begin{matrix}{A}_{i} ≃ ( {x}_{i} + {ρ}_{dB} ) & if {μ}_{i} + {ρ}_{dB} ≫ {μ}_{Y} \\ {A}_{i} ≃ y & if {μ}_{i} + {ρ}_{dB} ≫ {μ}_{Y} \\ {A}_{i} ≃ 0.5 ( {x}_{i} + y ) + c & otherwise\end{matrix}$$

$$Where c = 0.5 {ρ}_{dB} + 10 \frac{ln ( 2 )}{ln ( 10 )} .$$

Hereinafter, it is considered that μᵢ+ρ_{dB}»μ_{Y} if the deviation between μᵢ+ρ_{dB} and μ_{Y} y is greater than a fixed value d. This means μᵢ+ρ_{dB}−μ_{Y}≥d where d>0. Thus,

$$\{ \begin{matrix}{A}_{i} ≃ ( {x}_{i} + {ρ}_{dB} ) & if {μ}_{i} + {ρ}_{dB} - {μ}_{Y} \geq d \\ {A}_{i} ≃ y & if {μ}_{Y} - {μ}_{i} - {ρ}_{dB} \geq d \\ {A}_{i} ≃ 0.5 ( {x}_{i} + y ) + c & if \vert {μ}_{i} + {ρ}_{dB} - {μ}_{Y} \vert < d\end{matrix}$$

The same reasoning applies for the quantity Aⱼ between the random variables xⱼ and y:

$$\{ \begin{matrix}{A}_{j} ≃ ( {x}_{j} + {ρ}_{dB} ) & if {μ}_{j} + {ρ}_{dB} - {μ}_{Y} \geq d \\ {A}_{j} ≃ y & if {μ}_{Y} - {μ}_{j} - {ρ}_{dB} \geq d \\ {A}_{j} ≃ 0.5 ( {x}_{j} + y ) + c & if \vert {μ}_{j} + {ρ}_{dB} - {μ }_{Y} \vert < d\end{matrix}$$

Based on these approximations of Aᵢ and Aⱼ, the expressions of E[xᵢAᵢ], E[xⱼAⱼ] and E[AᵢAⱼ] become easy to calculate. Thus, it can be deduced therefrom E[SINRᵢ^{dB} SINRⱼ^{dB}]. Subsequently, during a step E36, the expression of E[SINRᵢ^{dB} SINRⱼ^{dB}] is injected into the equation EQ2 above to obtain the correlation coefficient between SINRᵢ^{dB} and SINRⱼ^{dB} for 1≤i≠j≤M₀.

It should be noted that
if τᵢⱼ >1, then τᵢⱼ=1
if τᵢⱼ <−1, then τᵢⱼ=−1.

These various steps referenced E31 to E36 make it possible to determine, during a step E37, the mean and the variance of the maximum of the SINRs on the logarithmic scale.

It should be noted that the step referenced E33 may be performed before, after or concomitantly with the steps referenced E34 to E36.

In a step E37, the mean and the variance of the maximum of SINRs are determined iteratively two by two, based on the C. E. Clark study, “The greatest of a finite set of random variables,” in Operations Research, Vol. 9, No. 2, 145-162, 1961, and on the correlation coefficient determined during the step E36.

For this purpose, a variable Z₁=max(SINR₁^{dB}, SINR₂^{dB}) is considered.

Then, according to C. E. Clark, “The greatest of a finite set of random variables,” in Operations Research, Vol. 9, No. 2, 145-162, 1961:

the mean of Z₁ is written:

$${q}_{Z 1} = f ( {q}_{1} , {q}_{2} , {s}_{1} , {s}_{2} , {τ}_{12} ) \qquad ( EQ4 \text{.1} )$$

the 2nd order moment of Z₁,

$$E [ {Z}_{1}^{2} ] = g ( {q}_{1} , {q}_{2} , {s}_{1} , {s}_{2} , {τ}_{12} ) \qquad ( EQ4 \text{.2} )$$

the variance of Z₁

$${s}_{Z 1}^{2} = E [ {Z}_{1}^{2} ] - {q}_{Z 1}^{2} \qquad ( EQ4 \text{.3} )$$

and the correlation coefficient between Z₁ and SINR₃^{dB} are respectively

$${τ}_{Z 1 , 3} = h ( {q}_{1} , {q}_{2} , {s}_{1} , {s}_{2} , {τ}_{12} , {τ}_{13} , {τ}_{23} ) \\ where f ( {q}_{1} , {q}_{2} , {s}_{1} , {s}_{2} , {τ}_{12} ) = {q}_{1} Φ ( \frac{{q}_{1} - {q}_{2}}{θ} ) + {q}_{2} Φ ( \frac{{q}_{2} - {q}_{1}}{θ} ) + θ ϕ ( \frac{{q}_{1} - {q}_{2}}{θ} ) g ( {q}_{1} , {q}_{2} , {s}_{1} , {s}_{2} , {τ}_{12} ) = ( {s}_{1}^{2} + {q}_{1}^{2} ) Φ ( \frac{{q}_{1} - {q}_{2}}{θ} ) + ( {s}_{2}^{2} + {q}_{2}^{2} ) Φ ( \frac{{q}_{2} - {q}_{1}}{θ} ) + ( {q}_{1} + {q}_{2} ) θ ϕ ( \frac{{q}_{1} - {q}_{2}}{θ} ) h ( {q}_{1} , {q}_{2} , {s}_{1} , {s}_{2} , {τ}_{12} {τ}_{13} , {τ}_{23} ) = \frac{{s}_{1} {τ}_{13} Φ ( \frac{{q}_{1} - {q}_{2}}{θ} ) + {s}_{2} {τ}_{23} Φ ( \frac{{q}_{2} - {q}_{1}}{θ} )}{\sqrt{g ( {q}_{1} , {q}_{2} , {s}_{1} , {s}_{2} , {τ}_{12} ) - {( f ( {q}_{1} , {q}_{2} , {s}_{1} , {s}_{2} , {τ}_{12} ) )}^{2}}} θ = \sqrt{{s}_{1}^{2} + {s}_{2}^{2} - 2 {τ}_{12} {s}_{1} {s}_{2}} , \qquad ( EQ4 \text{.4} )$$

ϕ(.) is the probability density function of the standard centered normal law and

Φ(.) and the distribution function of the standard normal law.

If it is now desired to calculate the same parameters for Z₂=max (Z₁, SINR₃^{dB} ), simply calculate q_{z2}=f(q_{z1}, q₃, s_{Z1}, S3, τ_{Z1,3}) and E[Z₂²]=g(q_{z1}, q₃, s_{Z1}, s₃, τ_{Z1,3}) then deduce s₂₂² therefrom.

If it is desired to calculate the parameters for Z₃=max (Z₂, SINR₄^{dB}), simply calculate qz3=f(q_{z2}, q₄, s_{z2}, s₄, τ_{Z2,4}) and E[Z₃^{2]=g(q}_{z2}, q₄, s_{z2}, s₄, τ_{Z2,4}) then deduce s_{Z3}² therefrom where τ_{z2,4}=h(q_{z1}, s₃, s_{Z1}, s₃, τ_{Z1,3}, τ_{Z1,4}, τ₃₄) and τ_{z1,4}=h(q₁, q₂, s₁, s₂, τ₁₂, τ₁₄, τ₂₄).

and so on up to SINR_{M}_{ₒ}^{dB}.

As mentioned above, the typical values of M₀ are 2, 3 or 4 cells. If: M₀=2, then the maximum SINR^{dB}=Z₁. The mean and the variance of SINR^{dB} are those of Z₁.

M₀=3, then the maximum SINR^{dB}=Z₂. The mean and the variance of

SINR^{dB} are those of Z₂.

M₀=4, then the maximum SINR^{dB}=Z₃. The mean and the variance of SINR^{dB} are those of Z₃.

Advantageously, the error on the estimation of the correlation coefficient has little impact on the accuracy for estimating the characteristic parameters of the SINR on the logarithmic scale (mean and variance). Therefore, it is possible to use a correlation coefficient mean as approximation of the correlation coefficient, because the error between the actual mean (respectively the variance) and that calculated based on the approximated correlation coefficient values is low.

Indeed, i.e. two correlated normal random variables of respective variances γ₁² and γ₂². I.e. τ the correlation coefficient between these two variables. According to the equations EQ4.1 and EQ4.3, the mean and the variance of the maximum of the two variables depends on the coefficient τ by means of the quantity α=\sqrt{γ₁²+γ₂²−τγ₁γ₂}.

Now, i.e. \hat{τ} an approximate value of τ, then

$$α = \sqrt{( {γ}_{1}^{2} + {γ}_{2}^{2} - 2 \tilde{τ} {γ}_{1} {γ}_{2} ) ( 1 - \frac{2 e {γ}_{1} {γ}_{2}}{{γ}_{1}^{2} + {γ}_{2}^{2} - 2 \tilde{τ} {γ}_{1} {γ}_{2}} ) ,}$$

where e=τ−\hat{τ}. When Δ≅1 (where

$$Δ = \sqrt{( 1 - \frac{2 e {γ}_{1} {γ}_{2}}{{γ}_{1}^{2} + {γ}_{2}^{2} - 2 \tilde{τ} {γ}_{1} {γ}_{2}} )} ) ,$$

α can be approximated by α≅\sqrt{γ₁²+γ₂²−2\hat{τ}γ₁γ₂}. In this case, the approximated value of the correlation coefficient can be considered in the calculations.

In this case, the approximated value of τᵢⱼ is the mean τ̅ᵢ̅ⱼ̅ for 1≤i≠j≤M₀.

In order to evaluate the accuracy of this approximation during the calculation of the correlation coefficients, the metrics of the relative error on the quantity Δ, i.e. therefore the quantity |Δ−1| is considered.

In order to validate this theoretical approach presented with reference to FIG. 3, the inventors of the present patent application simulated a network 1 with six cells, and considered a plurality of embodiments corresponding to a plurality of values of the standard deviation of the shadowing and a plurality of values of the deviation between the mean reception powers of the two cells having the highest mean reception powers.

They also varied the deviation between the mean reception powers with the other interfering cells. In particular, they simulate a network with M=6 cells and M0=4 potentially serving cells. We consider 3,000 Monte Carlo type embodiments corresponding to a plurality of values:
the mean reception power of a signal transmitted by the cell 1 such as −100≤μ₁≤−50 dBm,
the mean reception powers of the signals transmitted by cells knowing that μ₁−μᵢ≤λ for 2≤i≤4 because M₀=4 and μ₁−μᵢ<λ for 5≤i≤6 with λ=20 dB,
the standard deviation of the shadowing: 7≤σᵢ≤12 dB for 1≤i≤M,
4≤β≤10 dB,
0.4≤ρ≤0.9.

The value of dis set at 7. Since M₀=4, we have 6 correlation coefficients to calculate for each embodiment. In the table below, the percentage is given where the relative error on the calculation Δ is lower than or equal to 15%.

TABLE 1

| | Approx- | Approx- | Approx- | Approx- | Approx- | Approx- |
|---|---|---|---|---|---|---|
| | imation | imation | imation | imation | imation | imation |
| | of τ₁₂ | of τ₁₃ | of τ₁₄ | of τ₂₃ | of τ₂₄ | of τ₃₄ |
| \|Δ − 1\| < | 97.7% | 96.6% | 96.7% | 75% | 79% | 82.1% |
| 0.15 | | | | | | |

Table 1 shows the relative error on the value of Δ. The results of Table 1 justify the approximation by calculating the bounds of the correlation coefficient since the relative error is low (<0.15) in most cases.

We now calculate the maximum SINR, measured for the cell i. SINR/is the maximum between all the SINR coming from the potential serving cells M₀ for the same experiment scenario.

We compare the mean of the SINR on the logarithmic scale (that is denoted by S̅I̅N̅R̅_̅{̅d̅B̅}̅) relative to our theoretical approximation.

In FIG. 5, we give the bar chart of the absolute value of the error between S̅I̅N̅R̅_̅{̅d̅B̅}̅and the approximate value. We note that the theoretical method according to the development is able to estimate the maximum of the SINR given that the error on the mean does not exceed 1.5 dB in most cases.

We also note a low error on the estimation of the variance of the SINR with the method according to the development.

Now, in connection with FIG. 4, a second embodiment of the development is presented. In this particular embodiment, the steps referenced E41 to E44 and E46 are identical to the steps referenced E31 to E34 and E37, respectively, described above in connection with FIG. 3.

During a step E45, the expression of the SINRs (SINR₁, SINR₂ . . . SINR_{M}) measured for a user terminal capturing a radio signal transmitted by each of the cells of the set (CELL₁, CELL₂ . . . CELL_{M}) is modified during the step E42. More particularly, the number of cells causing interferences that may disturb the reception of a radio signal by the user terminal to be taken into account for calculating the SINRs is reduced to one. The cell causing interferences selected and kept for calculating the SINRs is the cell offering the highest mean reception power. In one example, it is assumed that the cell 1 (CELL1) is, from the set of cells determined in E41, the cell offering the highest mean reception power. In other words: μ₁≥μ₂≥ . . . ≥μ_{M}_{₀}.

Thus, this can then be written:

$${SINR}_{1} ≃ \frac{1 {0}^{\frac{{μ}_{1} + {ε}_{1}^{′}}{10}}}{ρ10 \frac{{μ}_{2} + {ε}_{2}^{′}}{10}} \\ And \\ {SINR}_{i} ≃ \frac{1 {0}^{\frac{{μ}_{i} + {ε}_{i}^{′}}{10}}}{ρ10 \frac{{μ}_{1} + {ε}_{1}^{′}}{10}}$$

for 2≤i≤M₀.

During the step E45, the value of the correlation coefficient is then approximated between the SINRs on the logarithmic scale from the values of the determined

SINRs by reducing the number of cells causing the interferences. Therefore,

$${τ}_{12} ≃ - 1 , \\ {τ}_{1 j} ≃ - \frac{{σ}_{1}^{′2}}{\sqrt{( {σ}_{1}^{′2} + {σ}_{2}^{′2} ) ( {σ}_{1}^{′2} + {σ}_{j}^{′2} )}} , for 3 \leq j \leq {M}_{0} \\ and$$

$${τ}_{ij} ≃ \frac{{σ}_{1}^{′2}}{\sqrt{( {σ}_{1}^{′2} + {σ}_{i}^{′2} ) ( {σ}_{1}^{′2} + {σ}_{j}^{′2} )}} , for 2 \leq i \neq j \leq {M}_{0}$$

Indeed, if the calculation is detailed, this gives:

$${SINR}_{1}^{dB} \text{?} {x}_{1} - {ρ}_{dB} - {x}_{2} and \\ {SINR}_{i}^{dB} \text{?} {x}_{i} - {ρ}_{dB} - {x}_{i} for 2 \leq i \leq {M}_{0} ; \\ where : {x}_{i} \text{?} {μ}_{i} + \text{?} for 1 \leq {M}_{0} \text{?} {ρ}_{dB} \text{?} 10 log ρ .$$

$$\text{?} \text{indicates text missing or illegible when filed}$$

So:

$$E [ {SINR}_{1}^{dB} ] \text{?} {μ}_{1} - {μ}_{2} - {ρ}_{dB} \text{?} var [ {SINR}_{1}^{dB} ] \text{?} {σ}_{1}^{′2} + {σ}_{2}^{′2}$$

$$\text{?} \text{indicates text missing or illegible when filed}$$

(“var” denotes variance)

And:

$$E [ {SINR}_{i}^{dB} ] \text{?} {μ}_{i} - {μ}_{1} - {ρ}_{dB} \text{?} var [ {SINR}_{\text{?}}^{dB} ] \text{?} {σ}_{1}^{′2} + {σ}_{i}^{′2}$$

$$\text{?} \text{indicates text missing or illegible when filed}$$

By using the approximated values of SINRᵢ^{dB}, the approximated value of the correlation coefficient is:

$${τ}_{i j} ≃ \frac{E [ {SINR}_{i}^{dB} {SINR}_{j}^{dB} ] - E [ {SINR}_{i}^{dB} ] E [ {SINR}_{j}^{dB} ]}{\sqrt{var [ {SINR}_{i}^{dB} ] var [ {SINR}_{j}^{dB} ]}}$$

Then:
for the coefficients between cells 1 and 2, this gives:

$$E [ {SINR}_{1}^{dB} {SINR}_{2}^{dB} ] ≃ E [ {SINR}_{1}^{dB} ] E [ {SINR}_{2}^{dB} ] - ( {σ}_{1}^{′2} + {σ}_{2}^{′2} )$$

Hence:
τ12≠−1.
for the coefficients between the cells 1 and j (3≤j≤M₀), this gives: E[SINR₁^{dB} SINRⱼ^{dB}]≅E[SINR₁^{dB}]E[SINRⱼ^{dB}]−σ₁′²

Thus:

$${τ}_{1 j} ≃ - \frac{{σ}_{1}^{′2}}{\sqrt{( {σ}_{1}^{′2} + {σ}_{2}^{′2} ) ( {σ}_{1}^{′2} + {σ}_{j}^{′2} )}}$$

for the coefficients between the cells i and j (2≤i≠j≤M₀), this gives:

$$E [ {SINR}_{i}^{dB} {SINR}_{j}^{dB} ] ≃ E [ {SINR}_{i}^{dB} ] E [ {SINR}_{j}^{dB} ] + {σ}_{1}^{′2} )$$

Hence:

$${τ}_{ij} ≃ \frac{{σ}_{1}^{′2}}{\sqrt{( {σ}_{1}^{′2} + {σ}_{i}^{′2} ) ( {σ}_{1}^{′2} + {σ}_{j}^{′2} )}}$$

Subsequently, as described above in connection with FIG. 3, in the step E37, during the step E46, the mean and the variance of the SINR^{dB}, or maximum SINR, is determined iteratively, using the preceding equations EQ4.1, EQ4.2, EQ4.3 and EQ4.4. We specify here that, in the equations EQ4.1, EQ4.2, EQ4.3 and EQ4.4, we use the exact values of the means and variances of SINRᵢ^{dB}, 1≤i≤M_0 (obtained in the step E44) and the approximate values of the correlation coefficients calculated above.

In order to validate this other theoretical approach in connection with FIG. 4, the inventors carry out as above the following experiment: simulation of a network with M=6 cells and M₀=4 potentially serving cells. 3,000 Monte Carlo type embodiments are considered corresponding to a plurality of values:
the mean reception power of a signal transmitted by the cell 1 such as −100≤μ₁≤−50 dBm,
the mean reception powers of the signals transmitted by cells knowing that μ₁μᵢ≤λ for 2≤i≤4 because M₀=4 and μ₁−μᵢ>λ for 5≤i≤6 with λ=20 dB,
the standard deviation of the shadowing: 7≤σᵢ≤12 dB for 1≤i≤M,
4≤β≤10 dB,
0.4≤ρ≤0.9.

In FIG. 6, we give the bar chart of the absolute value of the error between S̅I̅N̅R̅_̅{̅d̅B̅}̅ and the approximate value. We also note here that this theoretical method makes it possible to estimate the maximum of the SINR given that the error on the mean does not exceed 1.5 dB in most cases.

In addition, for this method, we note a low error on the estimation of the variance of the SINR.

Now, with reference to FIG. 7, the hardware structure of a system for monitoring the performance of a cellular radiocommunication network according to one embodiment of the development, or a system for planning the deployment of a cellular radiocommunication network, or a system for optimizing the operating parameters of a cellular radiocommunication network is presented.

Such a system referenced 5 comprises a unit for estimating the characteristic parameters of a reception quality in a location of the cellular radiocommunication network, and a unit for analyzing the performance of the network (respectively a unit for determining the parameters for planning the network or a unit for determining the optimized operating parameters of the network), depending on the estimated characteristic parameters.

The term “unit” may correspond to both a software component and a hardware component or a set of hardware and software components, a software component itself corresponding to one or more computer program(s) or sub-program(s), or more generally to any element of a program capable of implementing a function or a set of functions.

More generally, such a system 5 for monitoring the performance of the network (respectively system for planning the deployment of the network or system for optimizing the operating parameters of the network) comprises a random access memory M1 (for example a RAM), a processing unit 6 equipped for example with a processor, and controlled by a computer program, representative of the unit for estimating the characteristic parameters of a reception quality in a location of the cellular radiocommunication network, stored in a read-only memory M2 (for example a ROM or a hard drive). Upon initialization, for example, the code instructions of the computer program are loaded into the random-access memory MI before being executed by the processor of the processing unit 6. The random-access memory Ml particularly contains the various variables used in the calculations described above with reference to FIGS. 3 and 4. The processor of the processing unit 6 controls the calculation of the means and variances of the signal to interference plus noise ratios of the plurality of potential serving cells, the calculation of the correlation coefficient, as well as the calculation of the mean and of the variance of the SINR on the logarithmic scale, corresponding to the maximum of the ratios SINR^{dB}.

The random-access memory MI may also contain the results of the calculations carried out by the processor of the processing unit 6. It may provide these results to a unit for analyzing the performance of the network 7 (respectively a unit for determining the parameters for planning the network or a unit for determining the optimized operating parameters of the network), equipped with a processor and controlled by a computer program. This processor may be the same as that of the processing unit 6, or be different therefrom.

The system 5 also comprises an input/output I/O module 8 making it possible to return to the operator of the network the results of the analysis of the performance of the network carried out by the analysis unit 7 (respectively the results of the determination of the network planning parameters 7 or the results of the determination of the optimized operating parameters carried out by the unit for determining the optimized operating parameters of the network 7).

All the components M1, M2, 6, 7 and 8 of the system 5 are for example connected by a communication bus 9.

FIG. 7 only illustrates a particular way, from several possible, of producing the system for monitoring the performance of the network (respectively the system for planning the deployment of the network or the system for optimizing the operating parameters of the network), so that it carries out the steps of the method detailed above, with reference to FIGS. 1 to 4 (in any one of the various embodiments, or in a combination of these embodiments). Indeed, these steps may be implemented indifferently on a reprogrammable computing machine (a PC computer, a DSP processor or a microcontroller) executing a program comprising a sequence of instructions, or on a dedicated computing machine (for example a set of logic gates like an FPGA or an ASIC, or any other hardware module).

In the case where the system 5 for monitoring the performance of the network (respectively the system for planning the deployment of the network or the system for optimizing the operating parameters of the network) is produced with a reprogrammable computing machine, the corresponding program (that is to say the sequence of instructions) could be stored in a removable storage medium (such as for example, a flash drive, a CD-ROM or a DVD-ROM) or not, this storage medium being partially or totally readable by a computer or a processor.

1. A method of estimating the characteristic parameters of a reception quality in a location of a cellular radiocommunication network, wherein the method comprises:
selecting from a set of cells of said network, at least two cells offering the highest mean reception powers of a useful signal at said location (CELL₁, CELL₂ . . . CELL_{M});
determining, on the logarithmic scale, at least two signal to interference plus noise ratios at said location for said received useful signal coming from each of said at least two cells selected (SINR^{dB}₁, SINR^{dB}₂ . . . SINR^{dB}_{M});
determining a correlation coefficient between said at least two signal to interference plus noise ratios determined on the logarithmic scale;
determining a maximum between said at least two signal to interference plus noise ratios determined on the logarithmic scale; and
estimating said characteristic parameters of a reception quality at said location from said maximum and from said correlation coefficient.

2. The method of estimating the characteristic parameters of a reception quality according to claim 1, wherein said correlation coefficient is determined from an approximation of a mean of a product of said at least two signal to interference plus noise ratios.

3. The method of estimating the characteristic parameters of a reception quality according to claim 1, wherein said correlation coefficient is determined from:
a calculation of at least two signal to interference plus noise ratios only taking into account a single cell generating interferences offering the highest mean reception power of a useful signal at said location; and
at least two variances representative of an impact on the mean reception powers of said useful signal, of obstacles that said useful signal encounters during its propagation.

4. The method of estimating the characteristic parameters of a reception quality according to claim 1, wherein the method further comprises:
calculating a mean (q (SINR₁, SINR₂ . . . SINR_{M})) and a variance (s²(SINR₁, SINR₂ . . . SINR_{M})) of each of said at least two signal to interference plus noise ratios determined on the logarithmic scale,
and in that said correlation coefficient is determined according to the formula:
$${τ}_{ij} = \frac{E [ {SINR}_{i}^{dB} {SINR}_{j}^{dB} ] - {q}_{i} {q}_{j}}{{s}_{i} {s}_{j}}$$
where:
SINRᵢ and SINRⱼ respectively designate said at least two signal to interference plus noise ratios determined on the logarithmic scale of said at least two cells, qᵢ and qⱼ respectively designate said means of each of said at least two signal to interference plus noise ratios determined on the logarithmic scale, sᵢ and sⱼ respectively designate said variances of said at least two signal to interference plus noise ratios determined on the logarithmic scale.

5. The method of estimating the characteristic parameters of a reception quality according to claim 3, wherein said estimation of said characteristic parameters comprises calculating at least some of the elements belonging to the a group comprising:
a mean of said calculated maximum; and
a variance of said calculated maximum;
from said determined correlation coefficient and from the means and variances of each of said at least two signal to interference plus noise ratios determined on the logarithmic scale.

6. The method of estimating the characteristic parameters of a reception quality according to claim 5, wherein said mean of said calculated maximum is calculated according to the formula:
$${q}_{z} = {q}_{i} Φ ( \frac{{q}_{i} - {q}_{j}}{θ} ) + {q}_{j} Φ ( \frac{{q}_{j} - {q}_{i}}{θ} ) + θϕ ( \frac{{q}_{i} - {q}_{j}}{θ} )$$
where:
$$θ = \sqrt{{s}_{i}^{2} + {s}_{j}^{2} - 2 {τ}_{ij} {s}_{i} {s}_{j}} ,$$
ϕ(.) is the probability density function of the standard centered normal law,
Φ(.) is the distribution function of the standard normal law,
qᵢ and qⱼ respectively designate said means of each of said at least two signal to interference plus noise ratios determined on the logarithmic scale,
sᵢ² and sⱼ² respectively designate said variances of each of said two signal to interference plus noise ratios determined on the logarithmic scale, and
τᵢⱼ is said correlation coefficient between said two signal to interference plus noise ratios determined on the logarithmic scale.

7. The method of estimating the characteristic parameters of a reception quality according to claim 6, wherein said variance of said calculated maximum is calculated according to the formula:
$${s}_{z}^{2} = ( {s}_{i}^{2} + {q}_{i}^{2} ) Φ ( \frac{{q}_{i} - {q}_{j}}{θ} ) + ( {s}_{j}^{2} + {q}_{j}^{2} ) Φ ( \frac{{q}_{j} - {q}_{i}}{θ} ) + ( {q}_{i} + {q}_{j} ) θϕ ( \frac{{q}_{i} - {q}_{j}}{θ} ) - {( {q}_{z} )}^{2}$$
where:
$$θ = \sqrt{{s}_{i}^{2} + {s}_{j}^{2} - 2 {τ}_{ij} {s}_{i} {s}_{j}} ,$$
ϕ(.) is the probability density function of the standard centered normal law,
Φ(.) is the distribution function of the standard normal law,
qᵢ and qⱼ respectively designate said means of each of said two signal to interference plus noise ratios determined on the logarithmic scale,
sᵢ² and sⱼ² respectively designate said variances of each of said two signal to interference plus noise ratios determined on the logarithmic scale, and
τᵢⱼ is said correlation coefficient between said two signal to interference plus noise ratios determined on the logarithmic scale, and
q_{z} is said mean of said calculated maximum.

8. The method of estimating the characteristic parameters of a reception quality according to any one of claim 1, wherein said determination of said maximum between said at least two signal to interference plus noise ratios determined on the logarithmic scale, comprises, where applicable, determining, from said at least two cells selected, at least two cells mutually having an mean power difference greater than or equal to a predetermined threshold.

9. A processing circuit comprising a processor and a memory, the memory storing program code instructions of a computer program a to execute the method according to of claim 1, when the computer program is executed by the processor.

10. A method of planning the deployment of a cellular radiocommunication network, wherein the method implements an estimation of characteristic parameters of a reception quality in a location of said network according to claim 1 and a determination of parameters for planning said network depending on said estimated characteristic parameters.

11. A method of optimizing the operating parameters of a cellular radiocommunication network, wherein the method implements estimating characteristic parameters of a reception quality in a location of said network according to claim 1 and a determination of optimized operating parameters of said network depending on said estimated characteristic parameters.

12. A method of monitoring the performance of a cellular radiocommunication network, wherein the method implements estimating characteristic parameters of a reception quality in a location of said network according to claim 1 and an estimation of at least one performance criterion of said network depending on said estimated characteristic parameters.

13. A system for planning the deployment of a cellular radiocommunication network, wherein the system comprises a processor configured to execute the steps of the method for estimating the characteristic parameters of a reception quality in a location of said network according to claim 1 and for determining the parameters for planning said network depending on said estimated characteristic parameters.

14. A system for optimizing the operating parameters of a cellular radiocommunication network, wherein the system comprises a processor configured to execute the steps of the method for estimating the characteristic parameters of a reception quality in a location of said network according to claim 1 and for determining the optimized operating parameters of said network depending on said estimated characteristic parameters.

15. A system for monitoring the performance of a cellular radiocommunication network, wherein the system comprises a processor configured to execute the steps of the method for estimating the characteristic parameters of a reception quality in a location of said cellular radiocommunication network according to claim 1 and for analyzing a performance of said network depending on said estimated characteristic parameters.
